(19) United States
(12) Patent Application Publication
(10) Pub. No.: US 2023/0334457 A1
(43) Pub. Date: Oct. 19, 2023

(54) AUTOMATED DISTRIBUTION OF GRATUITIES

(71) Applicant: TipHaus, Inc., Port Orchard, WA (US)

(72) Inventors: Macgregor GAINOR, Bellingham, WA (US); Taylor BIRKELAND, Seattle, WA (US); Leif MAGNUSON, Seattle, WA (US)

(21) Appl. No.: 17/723,108

(22) Filed: Apr. 18, 2022

(51) Int. Cl. G06Q 20/22

(52) U.S. Cl. CPC G06Q 20/22

(57) ABSTRACT

This disclosure describes techniques for automated distribution of gratuities among employees in a business setting. In one example, a pooled amount of gratuity within a gratuity distribution period may be distributed to one or more employees that participated in one or more transactions within the gratuity distribution period. On account of variable conditions within the gratuity distribution period that correspond to changes in percentage sharing of the one or more employees, different corresponding algorithms (or calculations) may be used to determine portions of the pooled gratuity to be attributed to each employee. In one embodiment, a server may monitor the variable conditions and further utilizes a look-up table (LUT) to retrieve corresponding algorithms for the variable conditions.

### BACKGROUND

For certain service-based businesses, it is customary for customers to give a gratuity, or tip, to one or more employees who perform a service. Although a business customer may primarily interact with a subset of employees of the service-based business, such as a server and a host of a restaurant, many other employees may have contributed or assisted in varying degrees in supporting the service provided to the customer. In a restaurant, for example, a host may initially entertain and seat the customer to a table, a busser may set and clear the table, a food runner may deliver food to the table, a bartender may prepare and/or serve alcoholic beverages, a valet driver may bring customer's car to a main entrance, and other employees may similarly provide specific services for the benefit of the customer during their dining experience.

At an end of a customer transaction, such as when the customer pays for the service, the customer may have the opportunity to give a gratuity directly to the server or add the gratuity to an amount paid for the meal, for example. In some scenarios, the gratuity may then be shared among the employees who assisted in providing service to the customer or aggregated and distributed among employees regardless of whether they provided direct assistance for a specific transaction (e.g., dishwashers or maintenance personnel) according to customs or practices of a given business or industry. The sharing of gratuities has often been manually calculated and documented, complicating business accounting, employee earnings, and the like.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a diagram of an example network server environment that facilitates an automated distribution of gratuities among employees of a service establishment, in accordance with at least one embodiment.

FIG. 2 is a diagram of an example network server environment in which an accounting management server may be implemented, in accordance with at least one embodiment.

FIG. 3 is a diagram of an example of gratuity distribution over a particular gratuity distribution period, in accordance with at least one embodiment.

FIG. 4 is a diagram of an example of gratuity distribution over completed orders that span/range from an opening of the corresponding order/transaction to an entry of a time-of-sale for each of the orders/transactions, in accordance with at least one embodiment.

FIG. 5 is a block diagram of a look-up table (LUT) that that can be used for gratuity distribution by the accounting management server over the completed order, in accordance with at least one embodiment.

FIG. 6 is an example subscriber user interface that shows accessing of a tip management application (app) for manual configuration of various fields and conditions that may effect changes in gratuity percentages for a particular time window during a gratuity distribution period, in accordance with at least one embodiment.

FIG. 7 is a flow diagram of an example methodological implementation for reconciling an amount of pooled gratuity at an end of the gratuity distribution period for a particular employee, in accordance with at least one embodiment.

FIG. 8 is a flow diagram of an example methodological implementation for executing one or more sub-algorithms within the gratuity distribution period, in accordance with at least one embodiment.

### DETAILED DESCRIPTION

This disclosure describes techniques for automating reconciliation of gratuities among employees in a business setting. Distribution (or sharing) of gratuities may be based upon employees' percentage sharing of gratuities, where the employees' percentages can be associated with their assigned or actual working hours; participation over a particular service or order; length of overlapping shifts between employees; employees' positions/levels; day of the week, weekends, or holidays; and other conditions that relate to an apportioning of the gratuities pooled within a gratuity distribution period. The gratuity distribution period may include a distribution frequency of the gratuities to employees, which frequency can be hourly, daily, weekly, or some other periodic pattern. The gratuity distribution period can also be set according to an aperiodic factor such as, without limitation, when it is based on the time of sale where the gratuity distribution period can be defined by a start/opening of an order or transaction (such as, a bartender entering a liquor tab number for a customer or a host registering a particular dining table for the customer) to closing or entry of the time-of-sale (input data entries at, e.g., a register) for the rendered service or completed order; the time a delivery person leaves with an order until the order is delivered; or some other aperiodic pattern. The gratuity distribution period may be different from an employee's pay period or payment of wage, which can cover multiple gratuity distribution periods.

As described herein, gratuities may include tips, gifts, presents, donations, rewards, handouts, or other compensation that can be pooled, reconciled, and distributed to the employees in addition to any corresponding base wages. In one embodiment, a user such as a store manager may preconfigure the percentage sharing of a particular employee based upon the employee's time of work, participation over the rendered service or completed order, position or change in position during the rendering of the service or order, user profile, performance, and/or other criteria or parameters that can distinguish the percentage sharing of the particular employee from that of another employee. The percentage sharing may be a portion of a gratuity that can be attributed to an employee based upon any arbitrary preconfigured condition or conditions. In such embodiments, a distribution of a gratuity or gratuities may be implemented via execution of an algorithm to achieve percentage sharing of the employee over a particular time period or time window. The gratuities (or algorithm output data in some examples) may then be forwarded to one or more entities such as a bank or other financial institution, tax agency, bankruptcy court, collecting agency, credit card companies, etc. that can further utilize and process the output data for other purposes such as, without limitation, direct payment by bank of employee's wages, tax agency updating employee's income tax returns, bankruptcy court garnishing or levying the employee's gratuity shares/income, and the like. This technique of automating the distribution of the pooled gratuities over the gratuity distribution period may improve business accounting efficiency and can further increase cohesion among employees on account of visibility into the sharing to assure that gratuities are shared fairly and/or according to a known policy.

In one embodiment, a network server, such as an accounting management server, may execute the algorithm to implement the distribution of gratuities among employees of a particular subscriber establishment (or interchangeably referred to herein as a subscriber) such as, without limitation, a restaurant, carwash service, online or offline delivery provider, babysitter service, golf caddy operator, disc jockey service, and/or other similar subscriber that apportions pooled gratuities among their employees or workers for each gratuity distribution point, period, or cycle. In this embodiment, the accounting management server may use a tip management application (app) that can include hardware, software, or a combination thereof, to receive input data from the subscriber, process the input data, and generate output data that can be transmitted in real-time to the subscriber and/or another entity or entities such as a bank, tax agencies, etc.

In one embodiment, the tip management app may run the algorithm that can further comprise one or more sub-algorithms to generate the output data for a particular gratuity distribution according to a policy preset for the algorithm. The one or more sub-algorithms may be used to calculate portions of a gratuity or gratuities at different time windows within the gratuity distribution period. For example, when a particular employee fulfills a particular working shift or participates in a completion of an order, one or more conditions may occur that can trigger or be associated with a change in percentage sharing for that particular employee. In this example, the one or more conditions may trigger a different time window that can correspond to use of different variables and thus, different calculations (or sub-algorithms) of the gratuity sharing over corresponding time windows within the gratuity distribution period. In one example, a sub-algorithm for a particular time window may be triggered by an occurrence of a condition such as clocking in or out, or intervention, by another employee during the rendering of the service or order, change in working assignment between employees, or any other condition that changes the current percentage sharing of the employee over a particular time window. In this example, the occurrence of the condition may correspond to a change in the percentage sharing of the employee, time over which the sharing is attributable, etc. and thus, the need for a new calculation of the pooled gratuity or portion thereof to be shared.

In one example, an algorithm to determine the total gratuity earned and/or output data representing the same for a particular employee over a particular gratuity distribution period may include summing the total amount of gratuities earned by all employees during the gratuity distribution period, dividing the total amount of gratuities by the total number of minutes clocked in by all employees, and attributing a portion of the total amount of gratuities to the particular employee based upon the particular employee's percentage sharing per unit time of work within the particular time period. In another example, the algorithm may include a sub-algorithm to calculate a portion of the gratuity within a certain time window of the gratuity distribution period. In this other example, the running of the sub-algorithm may be triggered by a condition such as a clocking-in of another employee, change in work assignment of the employee, or other condition that changes the employee's previous percentage sharing of the pooled gratuity. In these examples, the gratuity distribution period can be periodic or aperiodic such as when the cycle is based upon an opening and closing of the order/transaction. The closing of the order, as defined herein, may include the entry of the time-of-sale data (also referred to as time-of-sale) where an amount of gratuity is entered as input data for further processing to generate the output data, which can be stored in an accounting database accessible by the network server, and the stored output data can be accessed by the subscriber or others authorized by the subscriber.

The implementation and operations described above are ascribed to the use of the server; however, alternative implementations may execute certain operations in conjunction with or wholly within a different element or component of the system(s). Further, the techniques described herein may be implemented in a number of contexts, and several example implementations and context are provided with reference to the following figures. In addition, the term “techniques,” as used herein, may refer to system(s), method(s), computer-readable instruction(s), module(s)m algorithms, hardware logic, and/or operation(s) as permitted by the context described above and throughout the document.

### Example Network Server Environment

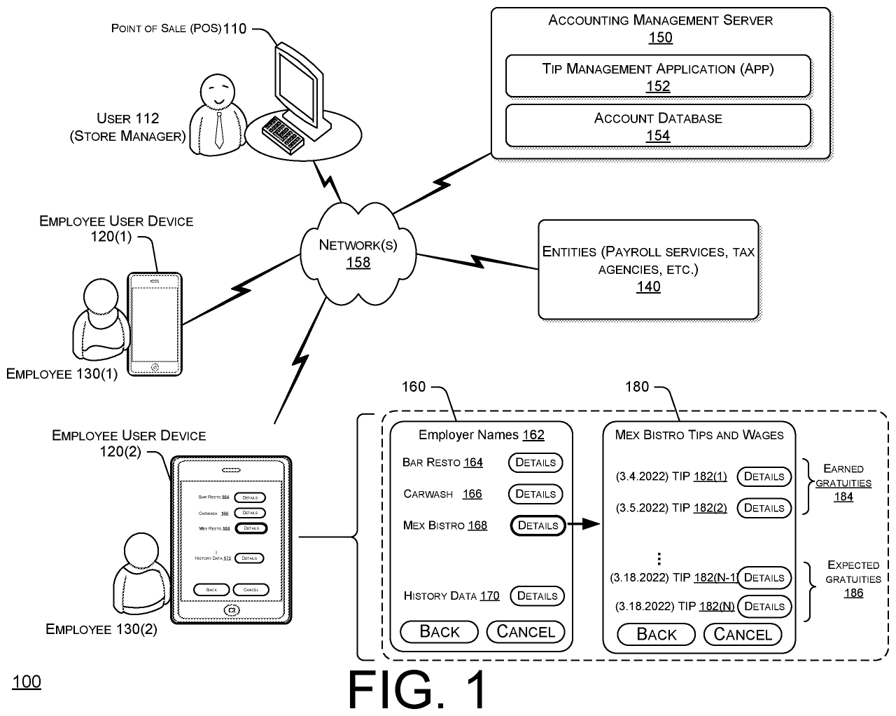

FIG. 1 illustrates a schematic view of a network server environment 100 that facilitates an automated distribution of gratuities among employees of subscriber-establishments (or subscribers) such as restaurants, carwash services, delivery providers, babysitter services, or similar employers or establishments that provide sharing of pooled gratuities among their employees or workers. In one embodiment, a network server, which can represent a subscription service provider, may receive input data from a subscriber, process the input data, generate output data that can indicate how gratuities are to be distributed, and transmit the output data back to the subscriber and/or other entities. The network server may also store, integrate, and/or reconcile output data that can include apportioned gratuities of employees who may be working for different subscribers. This technique of automating the distribution and/or reconciliation of gratuities may improve efficiency in business accounting practices on the part of the subscribers and further implement fair sharing of the gratuities among the subscribers' employees, contractors, sub-contractors, and the like.

As shown, the network environment 100 may include a point-of-sale device (POS) 110 of a particular subscriber, a user 112 such as a store manager, user devices 120(1), 120(2) that are associated with employees 130(1), 130(2), respectively, one or more entities 140, a network server such as an accounting management server 150, and one or more networks 158. The accounting management server 150 may further include a tip management app 152 and an account database 154. In some embodiments, the network environment 100 may be or include a cellular network.

Referencing the user device 120(2), and at a first instant 160, the employee 130(2) may view on the user device's user interface one or more of employee's employer names 162 such as a bar restaurant 164, carwash 166, and Mex bistro 168. A button link to history data 170 may also be shown at the first instant 160. At a second instant 180, and upon clicking/opening further details of the Mex bistro 168 by clicking the adjacent “Details” button, the employee 130(2) can also view their outstanding earnings, including earnings from gratuities 184 (which include tips 182(1)-182(N)) from different dates and/or gratuity distribution periods. Similarly, at the second instant 180, the employee 130(2) can view additional details such as expected gratuities 186. The earned gratuities 184 may include data in the account database 154 that can be further received and processed by the one or more entities 140 such as a bank that can facilitate direct payment of employee's payrolls/wages and/or gratuity earnings. As shown, the number of blocks, information, employees, and associated user devices are for illustration purposes only, and additional POSs, employees, and user devices can be included within the scope of the embodiments described herein.

The user 112 and employees 130(1), 130(2) may include individuals who are working for a subscriber establishment such as, without limitation, a restaurant, carwash center, hair parlor, and the like. In one embodiment, the user 112 may be a store manager who can configure, via the POS 110 and by accessing the accounting management server 150, the apportioning of gratuities among the employees over a gratuity distribution period, which can include a periodic cycle, aperiodic distribution frequency of the gratuities, or a combination thereof. For example, the periodic cycle may be every hour, end of day, end of week, or some other fixed time period. The aperiodic cycle can be after rendering of a particular service or completion of a customer order at the time-of-sale, random clocking in and out by an employee based upon a need of the subscriber, happening of an event during an employee's shift, or other aperiodic arbitrary condition that can be associated with calculation of the pooled gratuity.

In some embodiments, the configuring by the store manager 112 may include entering the employee's personal information, assigned job code, job position, percentage sharing for the job position or type of service, percentage sharing over an order or type of order to be completed, and adjustment in percentage sharing at a certain day of the week or upon occurrence of a condition. This data may be linked as described elsewhere herein such that, when the store manager 112 enters information or changes information in a field, data in another field may change accordingly (e.g., a change in job position may trigger an increase in gratuity percentage). The store manager 112 may also configure other parameters that can be used as variables by the algorithm and/or sub-algorithms to generate the output data over a particular gratuity distribution period.

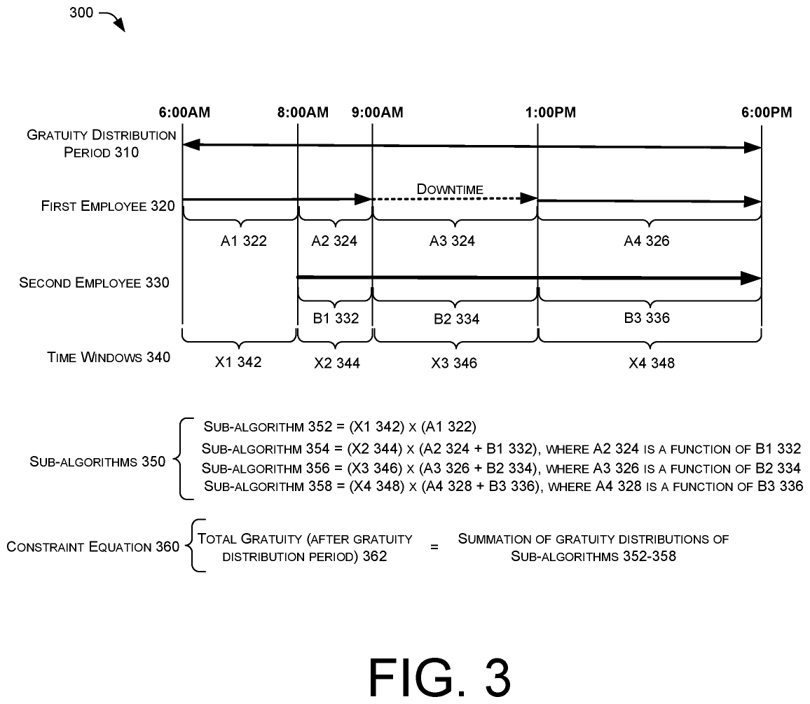

In one example, the generation of the output data over the particular gratuity distribution period may include running a plurality of sub-algorithms due to occurrence of conditions such as, without limitation, overlapping of working hours by employees, clocking in within a certain window by another employee occupying a different position, change in assignment of the employee, and similar conditions that trigger changes in percentage sharing of the employees. In this example, the occurrence of the condition may trigger execution of another sub-algorithm for purposes of accounting the gratuity earned by each of the employees at the end of the gratuity distribution period. Details of executing multiple sub-algorithms over different time windows are further described in FIG. 3.

In some embodiments, the POS 110 and/or the user devices 120(1), 120(2) may include an electronic communication device, including but not limited to, a smartphone, a session initiation protocol (SIP) phone, a laptop, a personal digital assistant (PDA), a satellite radio, a global positioning system (GPS), a multimedia device, a video device, a camera, a game console, a tablet, a smart device, a wearable device, or any other similar functioning device. In one embodiment, the POS 110, and/or the user devices 120(1), 120(2) may communicate with the accounting management server 150 to avail of automated distribution and/or reconciliation of gratuities as described in different embodiments herein.

A network server such as the accounting management server 150 may utilize distributed computing resources (e.g., one or more computing devices) that can operate in a cluster or other configuration to share resources, balance load, increase performance, provide fail-over support or redundancy, or for other purposes. The accounting management server 150 may include one or more interfaces to enable communications with the POS 110, user devices 120, and other networked devices via the one or more network(s) 158. The one or more network(s) 158 may include public networks such as the Internet, private networks such as an institutional and/or personal intranet, or some combination of private and public networks. The one or more network(s) 158 can also include any type of wired and/or wireless network, including but not limited to local area network (LANs), wide area networks (WANs), satellite networks, cable networks, Wi-Fi networks, Wi-Max networks, mobile communications networks (e.g., 3G, 4G, and so forth), or any combination thereof.

The one or more entities 140 may include another server or servers that can be operated by financial institutions, payroll agencies, tax agencies, bankruptcy court, credit card companies, collection agencies, payday loan lenders, creditors, or other institution that can process output data from the accounting management server 150. In one embodiment, the one or more entities 140 may implement access policies to control access by the subscribers to their corresponding output data or other subscriber information/data for further processing. The subscriber information/data may include the name of the subscriber, its (or its user) status and limit of authorization, etc.

In an example operation, the accounting management server 150 may be configured to execute one or more algorithms or sub-algorithms to determine how to distribute pooled gratuities over one or more gratuity distribution periods and for one or more different users. In this example operation, the sub-algorithms may be executed based upon occurrence of conditions and/or presence of other parameters that relate to the distribution of gratuities at the end of the gratuity distribution period.

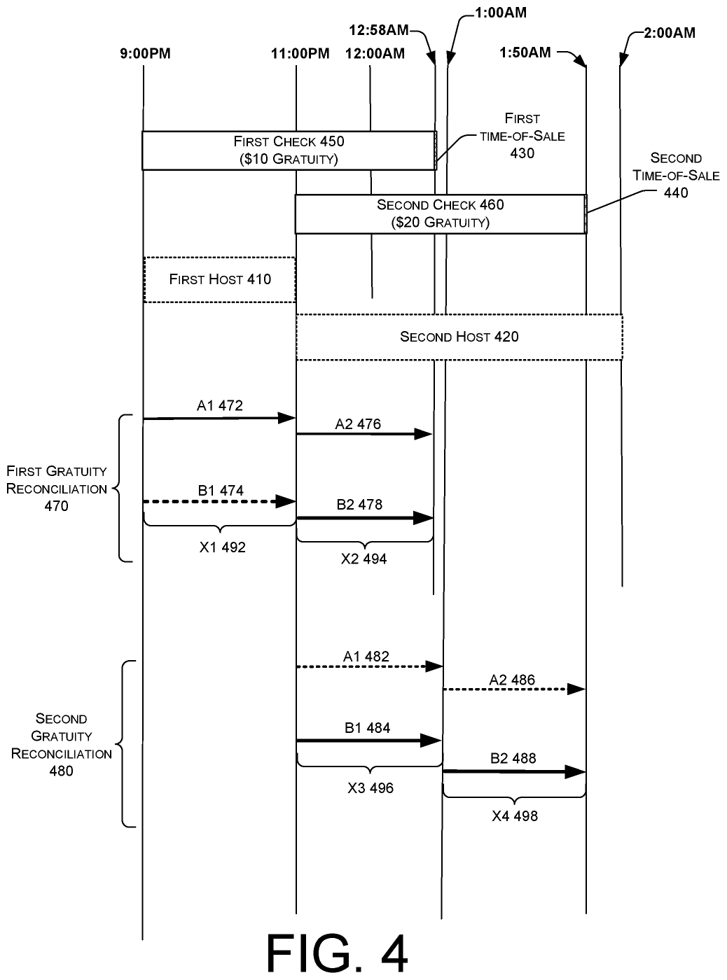

For example, employees 130(1) and 130(2) may have the same percentage sharing (or rate), position, assigned gratuity distribution period, etc. and worked for 2 hours (6:00 AM to 8:00 AM) in a particular working day. Assuming that the gratuity distribution period is 2 hours and employee 130(2) is assigned by the store manager to work at a different position at the second hour (7:00 AM to 8:00 AM), which corresponds to a different percentage sharing of pooled gratuity, then the gratuity distribution period of 2 hours may be subdivided into different time windows with different corresponding sub-algorithms to calculate respective portions of the total gratuity for each employee. The time windows, for example, may include a first time window between 6:00 AM to 7:00 AM where both employees have the same percentage sharing on the pooled gratuities, and a second time window between 7:00 AM to 8:00 AM where the change in position of the employee 130(2) triggers the use of another sub-algorithm due to the change in percentage sharing. The triggering of the sub-algorithm may be implemented, for example, upon detection of the change in assignment, which can be entered by the user 112 or by the employees themselves. In a case where the assignments of the employees were preconfigured, the triggering may be based upon the current time during the employees' working shifts. Further, in a case where the gratuity distribution period for both employees in the above example is based upon a beginning or a completion of an order where the order was opened at 6:00 AM and closed at 8:00 AM (time-of-sale), similar calculations can be performed to calculate the apportioning of the gratuities for both employees. Further details for calculating the pooled distribution at the time-of-sale is described in FIG. 4.

In one embodiment, the tip management app 152 may generate the gratuity earnings of the employees at the end of each gratuity distribution period. The gratuity earnings may be collated and summed at the end of the employees' individual pay periods. In addition, or in the alternative, the gratuity earnings of an individual employee may be summed, e.g., at the end of a work shift or even per transaction such as upon time-of-sale to complete an order or rendering of a service. The calculated gratuity earnings may be stored in the account database 154 where the stored data can be accessed by the user devices 120, the subscriber POS 110, one or more entities 140, and/or other network devices. In some cases, an authorization from the user 112 or subscriber may be needed for the other network devices to access the subscriber's or employee's data.

For example, the user device 120(2) that is associated with the employee 130(2) may be authorized to access the stored data to verify updates on the employee's previous, current, and expected gratuity income (if any). As shown at the first instant 160, the employee 130(2) can view at a user interface a different employer, if the employee holds more than one job whose employer also subscribes to the service that provides the automated distribution of gratuities. The employee 130(2) may then view additional details of each employment as shown at the second instant 180. Here, the employee can view the earned gratuities 184 and the expected gratuities 186 for the Mexican bistro in the illustrated example. In one embodiment, and every pay period, a particular entity such as an employee's bank may process the data from the accounting management server 150 to facilitate the direct deposit of the employee's earned gratuities 184 to the employee's bank account. In another embodiment, another entity such as a collecting agency may process the data from the accounting management server 150 to garnish the employee's earned gratuities 184 for child support, and so on.

### Example Network Server Implementation in a Network Server Environment

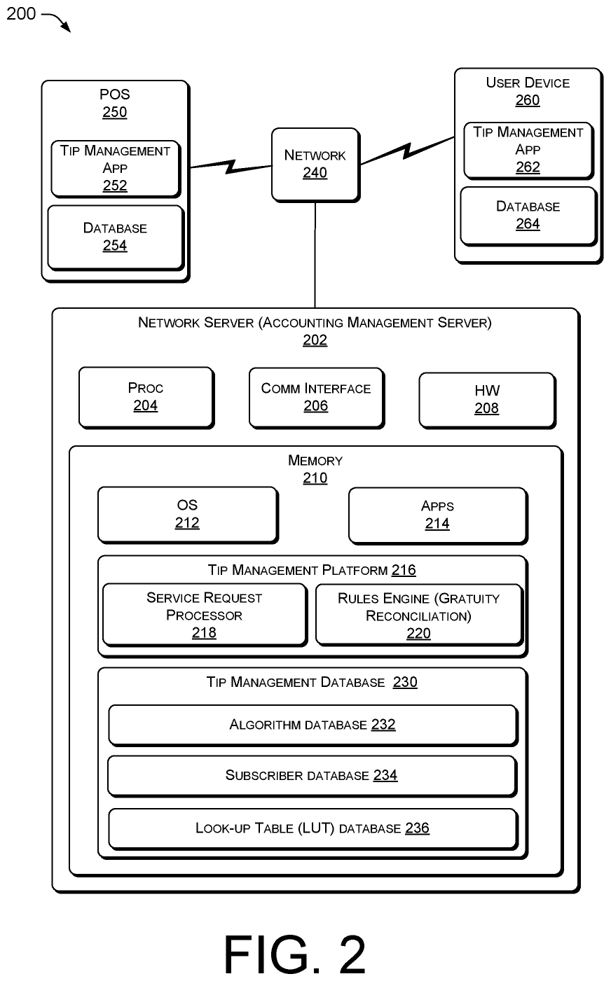

FIG. 2 is a diagram of an example network server environment 200 in which an accounting management server may be implemented, in accordance with at least one embodiment. For example, the network server environment 200 may include a network server 202 that corresponds to the accounting management server 150 of FIG. 1. The network server 202 may be communicatively connected, via a network 240, to a POS 250 and a user device 260. The POS 250 and the user device 260 may correspond to the POS 110 and the user device 120, respectively, of FIG. 1.

The network server 202 may include one or more processors 204 having electronic circuitry that executes instruction code segments by performing basic arithmetic, logical, control, memory, and input/output (I/O) operations specified by the instruction code. The processors 204 can be a product that is commercially available through companies such as Intel® or AMD®, or customized to work with and control a particular system.

The network server 202 also includes a communications interface 206 and miscellaneous hardware 208. The communication interface 206 may communicate with components located outside the network server 202 and provide networking capabilities for the network server 202. For example, the network server 202, by way of the communications interface 206, may communicate with subscribers and one or more entities that can be authorized by the subscribers to use the subscriber data. The subscriber data may include gratuities distributed at each gratuity distribution period and/or pay period, pending distributions that can include portions of gratuities for the gratuity distribution period, and associated subscriber information such as, without limitation, employee job codes, positions, hours of work, etc. Communications between the network server 202 and the user devices or requestor devices may utilize any sort of communication protocol known in the art for sending and receiving data and/or voice communications.

The miscellaneous hardware 208 may include hardware components and associated software and/or firmware used to carry out device operations. Included in the miscellaneous hardware 208 may be one or more user interface hardware components not shown individually—such as a keyboard, a mouse, a display, a microphone, a camera, and/or the like—that support user interaction with the network server 202.

The network server 202 also includes memory 210 that stores data, executable instructions, modules, components, data structures, etc. The memory 210 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms.

An operating system 212 may be stored in the memory 210 of the network server 202. The operating system 212 can control a functionality of the processor(s) 204, the communications interface 206, the miscellaneous hardware 208, and couples the processor(s) 204 with the memory 210. Furthermore, the operating system 212 may include components that enable the network server 202 to receive and/or transmit data via various inputs (e.g., user controls, network interfaces, and/or memory devices), as well as process data using the processor(s) 204 to generate output. The operating system 212 can include a presentation component that controls presentation of output (e.g., display the data on an electronic display, store the data in memory, transmit the data to another electronic device, etc.). Additionally, the operating system 212 can include other components that perform various additional functions generally associated with a typical operating system. The memory 210 that is in communication with the processor(s) 204 also stores various software applications 214, or programs, that provide or support functionality for the network server 202, or provide a general or specialized device user function that may or may not be related to the example computing device per se.

The one or more processors 204 and the memory 210 may implement a tip management platform 216 that may correspond at least in part to the tip management app 152 of FIG. 1, including such software as routines, program instructions, objects, and/or data structures that are executed by the processors 204 to perform particular tasks or implement particular abstract data types. The one or more processors 204 in conjunction with the tip management platform 216 may further operate and utilize a service request processor 218, a rules engine 220, and a tip management database 230 including an algorithm database 232, a subscriber database 234, and a look-up table (LUT) database 236.

The tip management platform 216, when executed, may manage the automated distribution and/or reconciliation of pooled gratuities among sub scriber employees over one or more gratuity distribution periods. The tip management platform 216 may run, for example, one or more algorithms and/or sub-algorithms to generate output data that may include gratuity earnings for each of the employees over the one or more gratuity distribution periods. The tip management platform 216 may be a single block of executable instructions or it may be made up of several components. The components included in at least one implementation are described elsewhere herein. However, it is noted that in some implementations, more or fewer components may be configured and that one or more operations attributed to a particular component in the following description may be implemented in one or more other components.

The service request processor 218 may process one or more service requests that can be received from the POS 250 or user devices that are associated with the subscriber's employees. One functionality of the service request processor 218 may be to verify the source of the service request. For example, the service request processor 218 may parse the parameters of the received service request and use the parsed parameters, such as an identification of the user device 260, to verify whether the device identification is associated with a particular subscription. In this example, the subscriber may authorize during an initial sign up or during a period of subscription to the tip management platform 216 the user device or devices, POSs, and/or entities that can access subscriber data or employee data. Access to the subscriber data or employee data may be performed via use of a username, email address, job code, and/or the like.

The rules engine 220 may be configured to run one or more algorithms to reconcile the pooled gratuities over one or more gratuity distribution periods for each of the subscriber establishments. A subscriber may utilize different algorithm(s) from another subscriber. In one embodiment, the rules engine 220 may run multiple sub-algorithms to calculate portions of gratuities for different time windows within a particular gratuity distribution period. In this embodiment, the different sub-algorithms may be triggered by changes in percentage sharing of the subscriber employees. Details of multiple time windows and corresponding sub-algorithms are further described with respect to FIGS. 3 and 4.

The algorithm database 232 may store preconfigured algorithms and/or sub-algorithms, associated variables, and other information that can be used for corresponding algorithms and/or sub-algorithms. In one embodiment, the conditions that trigger the running of a sub-algorithm may be preconfigured via an initial input from the user 112. The conditions may include clocking in by another employee during rendition of a service or completion of an order, changing of working assignment, or similar scenario that changes percentage sharing of the employee within a gratuity distribution period.

The subscriber database 234 may store the information associated with the subscriber establishments, such as name of the establishment, nature of establishment, employee information, gratuity distribution periods observed by the subscribers for their employees, authorized subscriber personnel who can configure percentage sharing of the employees, different sources of gratuities within the subscriber establishment, and the like. In one example, the employee information may include personal information, the device identification associated with the employee, employee position, and the like.

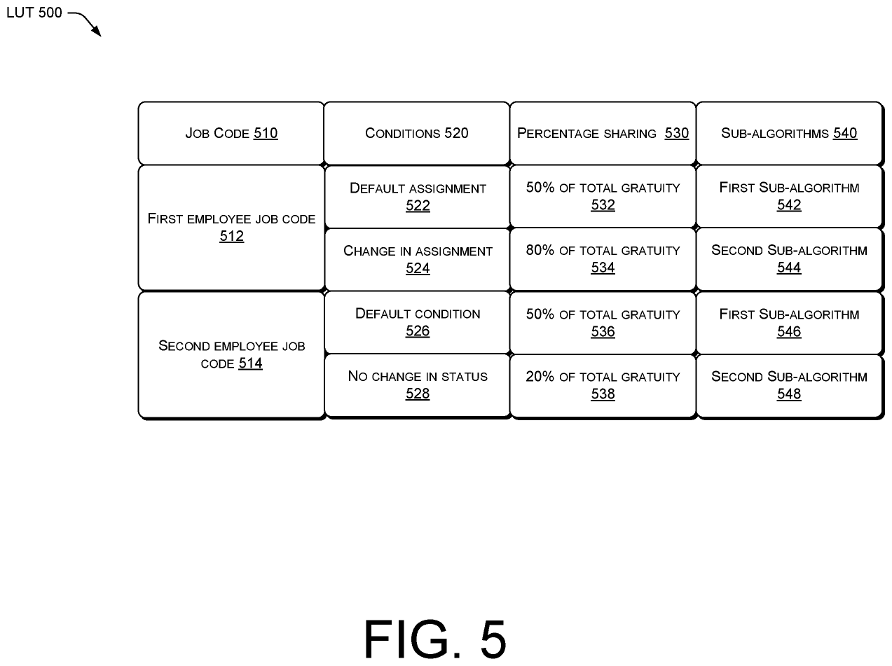

The LUT database 236 may store preconfigured variables associated with the algorithm(s) for distributing the gratuities in the subscriber establishments as described herein. In one embodiment, a particular percentage sharing of a particular employee is associated with a particular one or more conditions that can be represented by different variables. In this embodiment, the LUT may include the particular percentage sharing of the employee for the particular one or more conditions. When a monitored condition occurs, a new time window is generated and the LUT can be used to identify the corresponding sub-algorithm to be used over the new time window within the gratuity distribution period. Details of the LUT are further described in FIG. 5.

In one example, the POS 250 may be associated with the subscriber establishment and include components such as a tip management app 252 and a database 254. In this example, the POS 250 may be used to periodically or in real-time send input data to the network server 202 for further processing. The input data may include, without limitation, sales entries, amounts of gratuities, timestamp for payment of gratuities, timestamp for opening a transaction such as entering a tab number for a customer or designating a dining table for the customer, timestamp for ending of rendering service to customers or completing an order such as entering bill payment or closing of the tab number, clocking in and out by employees, changes in gratuity distribution period, assigned percentage sharing for certain position, adjustments in percentage sharing of the employee, and other data that relate to the distribution of gratuities over one or more gratuity distribution periods.

The user device 260 may be the employee's electronic device that can be used to access the employee's gratuity earnings from one or more employers and/or one or more gratuity distribution periods. In one example, the user device 260 may utilize the tip management app 262 to access the network server 202. The user device 260 may also include the database 264 to store data related to employee's expected wages, available wages, and/or other information that is related to the employee's gratuity earnings. Example Implementation of Reconciling Gratuities Using Sub Algorithms

FIG. 3 is a diagram of an example of gratuity distribution 300 over a particular gratuity distribution period, in accordance with at least one embodiment. FIG. 3 shows a gratuity distribution period 310 (e.g., 6:00 AM-6:00 PM), a first employee 320, second employee 330, time window 340, sub-algorithms 350, and a constraint equation 360. The first employee 320 and the second employee 330 may correspond to employees 130(1) and 130(2) of FIG. 1, respectively.

FIG. 3 shows time windows 340, which include time window X1 342, time window X2 344, time window X3 346, and time window X4 348 that can represent different time windows within the gratuity distribution period 310. The time windows can include unit values of minutes, hours, days, or other time period that is equal to or less than the gratuity distribution period. For the first employee 320, variables A1 322, A2 324, A3 326, and A4 324 may represent the first employee's corresponding percentage sharing over different the time windows X1 342, X2 344, X3 346, and X4 348, respectively. For the second employee 330, variables B1 332, B2 334, and B3 336 may represent the second employee's corresponding percentage sharing over the time windows X2 344, X3 346, and X4 348, respectively. For a particular time window, the percentage sharing of the first employee 320 may be a function of or at least related to the percentage sharing of second employee 330. For example, the percentage sharing of the first employee 320 is 80% while the percentage sharing of the second employee 330 is 20% for the time window X2 344. In this example, the percentage sharing of the first employee 320 may be a function of the percentage sharing of the second employee 330 since the total percentage sharing totals 100% of a portion of the pooled gratuity to be distributed at the time window X2 344. In some embodiments, different arbitrary conditions other than overlapping shifts may be associated with the percentage sharing of the first employee 320 and the second employee 330. For example, a change in assignment or an occurrence of an open bar doubles activities to be performed by the first employee 320. In this example, the change in assignment or occurrence of the open bar may include the condition that can be associated with the percentage sharing of the first employee 320. The change in assignment or the occurrence of the open bar may be implemented via manual entries by the corresponding employee or in some cases, can be preconfigured to occur at a certain hour within the gratuity distribution period 310.

The different associated conditions may trigger different time windows due to changes in an employee's percentage sharing that correspond to different sub-algorithms or calculations. For illustration purposes, the first employee 320 and the second employee 330 may have the same gratuity distribution period of 12 hours (6:00 AM to 6:00 PM). Further, the total amount of gratuities at the end of the gratuity distribution period 310 may include a summation of gratuities earned by the first employee 320 and the second employee 330 over the different time windows as demonstrated by a constraint equation 360.

The gratuity distribution period 310 may include a cycle for apportioning gratuities to the employees. The cycle may include a periodic or aperiodic time period that can be preconfigured for each employee and can be different between days of the week, holidays, presence of events, and the like. In one embodiment, the gratuity distribution period 310 for each employee may be adjusted based on days of the week, holidays, employee's assignment, work hours, time of sale, section in the subscriber establishment such as valet section, bar section, dining section, and the like. In this embodiment, the adjusted gratuity distribution period 310 may still include one or more time windows depending upon the occurrence of conditions that trigger changes in percentage sharing of the employees that claim a share in the pooled gratuity over that particular time window.

Each of the time windows X1 342, X2 344, X3 346, and X4 348 may represent a time period within the gratuity distribution period 310, where changes in percentage sharing for the reconciliation of the gratuities may require a different form of calculation or sub-algorithm. For example, sub-algorithms 352-358 may be executed for the time windows X1 342, X2 344, X3 346, and X4 348, respectively. In this example, each of the sub-algorithms may be triggered by an occurrence of a condition that changes the percentage sharing of at least one of the employees over a particular gratuity distribution period. Here, the variables A1 322, A2 324, A3 326, and A4 324 may respectively include preconfigured percentage sharing of the first employee 320 based upon the occurrence of the corresponding conditions. Similarly, the variables B1 332, B2 334, and B3 336 may include preconfigured percentage sharing of the second employee 330 based upon the occurrence of the corresponding conditions. These conditions and corresponding percentage sharing may be stored in the LUT.

Referencing FIG. 3, a particular working shift of the first employee 320 may include working between 6:00 AM-6:00 PM with a four hour downtime (e.g., time away from tipped work) between 9:00 AM-1:00 PM. Similarly, the working shift of the second employee 330 may include working between 8:00 AM-6:00 PM. In this scenario, a change in condition may occur at 8:00 AM that triggers the time window X2 344 when the second employee 330 clocks in and the working shift of the second employee overlaps with the working shift of the first employee. Similarly, another change in condition occurs and triggers the time window X3 346 when the first employee leaves the tipped shift while the second employee remains. Another change in condition may trigger the time window X4 348 when the first employee comes back from downtime, and their working shifts overlap again between 1:00 PM-6:00 PM. Each of the occurring conditions in this example may correspond to changes in the percentage shares of the employees and thus, the use of different sub-algorithms. In one embodiment, the changes in conditions may be monitored and detected based upon a timestamp of the clocking in and out of the employees in the subscriber-establishment, current time clock or time of day, or a combination thereof. In this embodiment, each of conditions may be associated with a job code of the employee, job title, job assignment, or other parameter that can identify and associate the employee to the changes in conditions.

Upon identification of the different time windows within the gratuity distribution period 310, the accounting management server may run the sub-algorithms 352-358 to determine distribution of the gratuities for the corresponding time windows. For example, sub-algorithm 352 may be based upon multiplication of X1 342 and A1 322. In this example, X1 342 may include a time period while A1 322 corresponds to the percentage sharing of the first employee 320 over the X1 322 time window. In another example, sub-algorithm 354 may be based upon multiplication between X2 344 and A2 324, and between X2 344 and B1 332. In this other example, the sub-algorithm 354 may treat the variable A2 324 as a function of the variable B1 332. By using the constraint equation 360, the two unknown variables may be determined. The A2 324 and B1 332 may represent the percentage sharing of first employee 320 and second employee 330 over the X2 344 time window.

In another example still, the sub-algorithm 356 may be based upon multiplication between X3 346 and A3 326, and between X3 346 and B2 334. Here, the sub-algorithm 356 may also treat the variable A3 326 as a function of the variable B2 334. The A3 326 and B2 334 may represent the percentage sharing of the first employee 320 and the second employee 330 over the X2 344 time window, and so on.

Upon determination of percentage sharing by each employee over each of the time windows, the accounting management server may sum the gratuities at each time window to generate the output data for each employee.

### Example Implementation of Reconciling Gratuities Based Upon Time-of-Sales

FIG. 4 is a diagram of an example of gratuity distribution over completed orders that span/range from an opening of the corresponding order/transaction to an entry of a time-of-sale for each of the orders/transactions. The entry of the time-of-sale may indicate the completion of the corresponding transaction such as when actual payment is made for the service rendered or completion of a customer's order (e.g., payment of a bar tab bill). FIG. 4 illustrates a reconciliation of pooled gratuity upon the entry of the time-of-sale, which can define an end of the corresponding aperiodic gratuity distribution period for the rendered service or completed order. As shown, a first host 410 and a second host 420 may represent subscriber employees while a first time-of-sale 430 and a second time-of-sale 440 can represent entries of a first check 450 and a second check 460, respectively. The first check 450, for example, may include payment of a bar tab that was opened by a first customer (not shown) at 9:00 PM and closed at 12:58 AM while the second check 460 can include another payment for a separate bar tab that was opened by a second customer (not shown) at 11:00 PM and closed at 1:50 AM. The opening of the bar tab may include an entry of a bar number (not shown) that can be assigned or associated with a particular customer while the closing of the bar tab may include an entry of payment or other information that can indicate a completion of transaction. FIG. 4 further shows a first gratuity reconciliation 470 and a second gratuity reconciliation 480 that can represent apportioning of the pooled gratuities at the time of the first time-of-sale 430 and the second time-of-sale 440, respectively.

Referencing the first gratuity reconciliation 470, A1 472 and B1 474 may represent respective percentage sharing of the first host 410 and the second host 420 at a first time window X1 492. Further, A2 476 and B2 478 may represent respective percentage sharing of the first host 410 and the second host 420 at a second time window X2 494.

Referencing the second gratuity reconciliation 480, A1 482 and B1 484 may represent respective percentage sharing of the first host 410 and the second host 420 at a third time window X3 496. Further, A2 486 and B2 488 may represent respective percentage sharing of first host 410 and the second host 420 at a fourth time window X4 498.

In one embodiment, the first time-of-sale 430 may define an end of a aperiodic gratuity distribution period and can be associated with a completion of a transaction that is paid using the first check 450. For example, the transaction was opened at 9:00 PM and closed at 12:58 AM upon an entry of transaction payment, which is represented by the first time-of-sale 430. In this example, the pooled gratuity ($10) may be immediately apportioned to the first host 410 and the second host 420 upon completion of the transaction. The reconciliation of the pooled gratuity ($10) at the first time-of-sale 430 may utilize the use of sub-algorithms for different time windows as described in FIG. 3 above.

For example, referencing the first gratuity reconciliation 470, the first time window X1 492 and the second time window 494 may correspond to different percentage sharing by the first host 410 and the second host 420 over different time periods within the aperiodic gratuity distribution period of 3 hours and 58 minutes (i.e., 9:00 PM to 12:58 AM). At the first time window X1 492, note that even though there is no overlapping between working shift/hours by the second host 420 (11:00 PM to 2:00 AM) with the first host 410 (9:00 PM to 11:00 PM), one or more arbitrary conditions other the overlapping of working hours may be associated with the percentage sharing—B1 474 of second host 420. For example, the second host 420 is preconfigured to share 10% of a portion of the gratuity during the first time window X1 492 on account of the second host's position even though the second host did not work between 9:00 PM to 11:00 PM.

Referencing the second time window X2 494 of the first gratuity reconciliation 470, the second time window X2 494 may be triggered by changes in the percentage sharing of the first host 410 and the second host 420 upon an occurrence of a condition such as the clocking in by the second host 420 at 11:00 PM. Here, a different sub-algorithm may be utilized to calculate the respective percentage sharing of the first host 410 and the second host 420 of the portion of the gratuity at the second time window X2 494. In some instances, the percentage sharing of the first host 410 and the second host 420 at the first time-of-sale 430 may be linearly based upon number of minutes they served or provided for the completion of the transaction. In these instances, the first host 410 and the second host 420 may divide the $10 pooled gratuity based upon their number of work hours such as 2 hours (9:00 PM to 11:00 PM) for the first host 410 and 1 hour 58 minutes (11:00 PM to 12:58 AM) for the second host 420.

In one embodiment, the amount of gratuity to be pooled ($10) at the first time-of-sale 430 may be equated with each sub-algorithm to calculate the apportioned gratuities for the first host 410 and the second host 420. Since the percentage sharing of the first host 410 is a function of the percentage sharing of the second host 420, then the percentage sharing of each host may be calculated.

Referencing the second gratuity reconciliation 480, the second time-of-sale 440 may define an end of another aperiodic gratuity distribution period and can be associated with a completion of a transaction that is associated with the second check 460. For example, the transaction was opened at 11:00 PM and closed at 1:50 AM upon an entry of transaction payment, which is represented by the second time-of-sale 440. In this example, the pooled gratuity ($20) may be immediately apportioned to the first host 410 and the second host 420 upon completion of the transaction. The reconciliation of the pooled gratuity ($20) at the second time-of-sale 440 may similarly utilize the use of sub-algorithms for different time windows as described in FIG. 3 above.

For example, referencing the second gratuity reconciliation 480, the third time window X3 496 and the fourth time window 498 may correspond to different percentage sharing by the first host 410 and the second host 420 over different time periods within the aperiodic gratuity distribution period of 2 hours and 50 minutes (11:00 PM to 1:50 AM). At the third time window X3 496, note that even though there is no overlapping between working hours of the second host 420 (11:00 PM to 2:00 AM) with the first host 410 (9:00 PM to 11:00 PM), one or more arbitrary conditions other the overlapping of working hours may be associated with the percentage sharing A1 482 of the first host 410. For example, the first host 410 is preconfigured to have a percentage share of A1 482 for the third time window X3 496 on account of first host's position even though the first host did not work between 11:00 PM to 1:00 AM. At the fourth time window X4 498, the first host 410 may be preconfigured to have a different percentage share—A2 486 on account, for example, of first host's reward as employee of the year even though the first host did not work between 1:00 AM to 1:50 AM. In these examples, the one or more arbitrary preconfigured conditions that can be associated with each host can be programmed by subscriber administrator such as a store manager. Further, the preconfigured one or more conditions can be preconfigured at different cycles like implementing aperiodic gratuity distribution periods for first half of the month and observing periodic gratuity distribution periods at the second half.

Similar to the first gratuity reconciliation 470, the amount of gratuity to be pooled ($20) at the second time-of-sale 440 may be equated with each sub-algorithm to calculate the apportioned gratuities for the first host 410 and the second host 420. Since the percentage sharing of the first host 410 is a function of the percentage sharing of the second host 420, then the percentage sharing of each host may be calculated.

The embodiment as described above is for simplicity of illustration and different other arbitrary conditions may be associated that can trigger the use of different sub-algorithms. For example, and during an overlapping of shifts (not shown) between the first employee 320 and the second employee 330, multiple orders for the same opened transaction may be alternately entered by the first employee 320 or the second employee 330. This happens in a bar where multiple bartenders may serve the same tab number. In this example, the percentage sharing during this overlapping period may be based upon number of orders entered, amount of order entered, or other arbitrary conditions that can be configured and associated with a particular percentage sharing of the first employee 320 and the second employee 330 during this overlapping period. In this example still, a similar process for the distribution of the gratuity as described above can be implemented.

FIG. 5 is a block diagram of an example look-up table (LUT) 500 that that can be used for gratuity distribution by the accounting management server over the completed transaction such as upon the time-of-sale as described in FIG. 4 above. The example LUT 500 can be used by the accounting management server to identify the sub-algorithms associated with percentage sharing and other information that are associated with job codes. The job codes may represent a particular position and/or employee identification for purposes of determining the distribution of the gratuity that can be attributed to the employee at the end of each gratuity distribution period.

As shown, the LUT 500 may include a job code 510, conditions 520, a corresponding percentage sharing 530, and associated sub-algorithms 540. The job code 510 can be representative of any employee position such as manager, bartender, busser, chef, valet driver, and the like. For illustration purposes, only two job codes 510 are shown, including a first employee job code 512 and a second employee job code 514.

The conditions 520 may include preconfigured arbitrary criteria that can be associated with the percentage sharing of the corresponding job code. For example, the conditions 520 may include an initial default assignment 522 and a change in assignment 524 for the first employee job code 512. Here, a detected change in assignment 524 from the initial default assignment 522 may trigger a change from a first sub-algorithm 542 corresponding to the default assignment 522 to use of a new sub-algorithm such as the second sub-algorithm 544. In this example, the first sub-algorithm 542 may be used in the previous default condition 542 where the first employee job code 512 and the second employee job code 514 are configured to share equally the amount of gratuities to be reconciled. However, upon detection of the change in assignment of the first employee job code 512, the second sub-algorithm 544 may be used to reflect changes in the corresponding percentage share 530 between the first employee job code 512 and the second employee job code 514.

In the example shown in FIG. 5, the change in assignment 524 may cause the second sub-algorithm 544 to change the division of gratuities between the first employee and the second employee from an entry 532 of 50% of the total gratuity associated with the first employee job code 512 and an entry 536 of 50% of the total gratuity associated with the second employee job code 514 to an entry 534 of 80% of the total gratuity associated with the first employee job code 512 and an entry 538 of 20% of the total gratuity associated with the second employee job code 514. In this example, there is no change in the status of the corresponding condition (assignment) associated with the second employee job code 514, as shown at 528. However, in another example, a change in an assignment or other condition associated with the second employee and second employee job code may trigger a change in the percentage sharing by, e.g., causing a change from a first sub-algorithm 546 associated with the default condition 526 to a second sub-algorithm 548 associated with the change in condition.

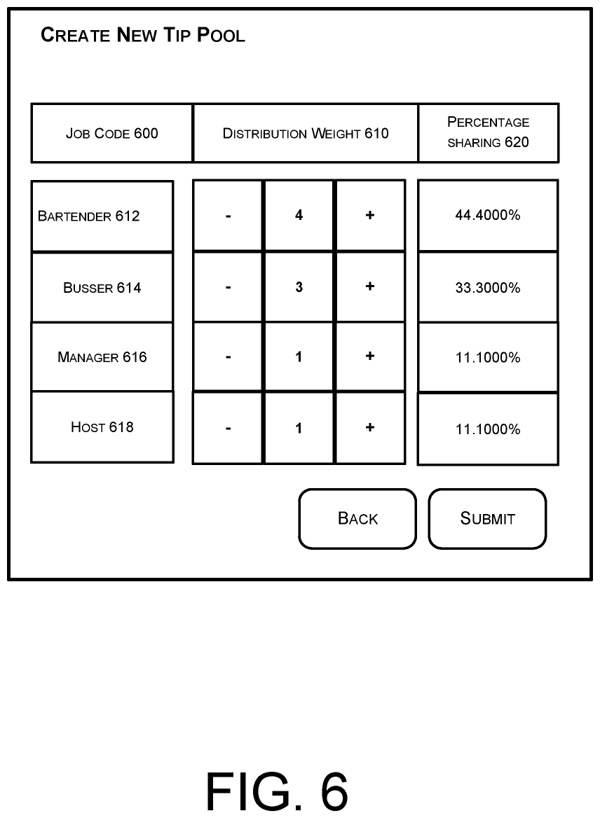

FIG. 6 is an example subscriber user interface that shows accessing of the tip management app to manually configure various fields and conditions that may effect changes in gratuity percentages for a particular time window during a gratuity distribution period, in accordance with at least one embodiment. As shown, the subscriber user interface may include fields for entry of parameters, e.g., by a subscriber/user, to enforce a gratuity distribution policy. In the illustrated example, those fields may include entries for a job code 600, a distribution weight 610, and percentage sharing 620 for the job code 600. The job code 600 and the percentage sharing 620 may correspond to the job code 510 and percentage sharing 530, respectively, of FIG. 5.

In the example shown in FIG. 6, which is not limited to the fields or values shown, job codes 600 may include code 612 for a bartender, code 614 for a busser, code 616 for a manager, and code 618 for a host. In one embodiment, the percentage sharing 620 may be used as a variable in corresponding sub-algorithms as described above. As illustrated, the subscriber (e.g., manager, supervisor, data entry clerk, or the like) may enter values for the distribution weight 610 or percentage sharing 620 for each job code 600 via the POS user interface to adjust on the fly the amount of gratuities associated with each job code. In some embodiments, additional conditions may be associated with each of the job code 600 that can change their percentage sharing similar to the triggering of conditions as described in FIGS. 3-4 above. Such conditions would have corresponding fields on the user interface so that the subscriber may alter the distribution amounts by making changes in those conditions in a similar manner.

In one example, adjustments of the distribution weights and other parameters that are tied to distribution amounts may be forwarded to the network server, and the network server may adjust the LUT information that can be associated with the employee job codes. In this example, the network server may perform automated distribution of gratuities on behalf of the subscriber as described herein.

### Example Implementation—Reconciling Pooled Gratuities Upon Entry of Time-of Sale

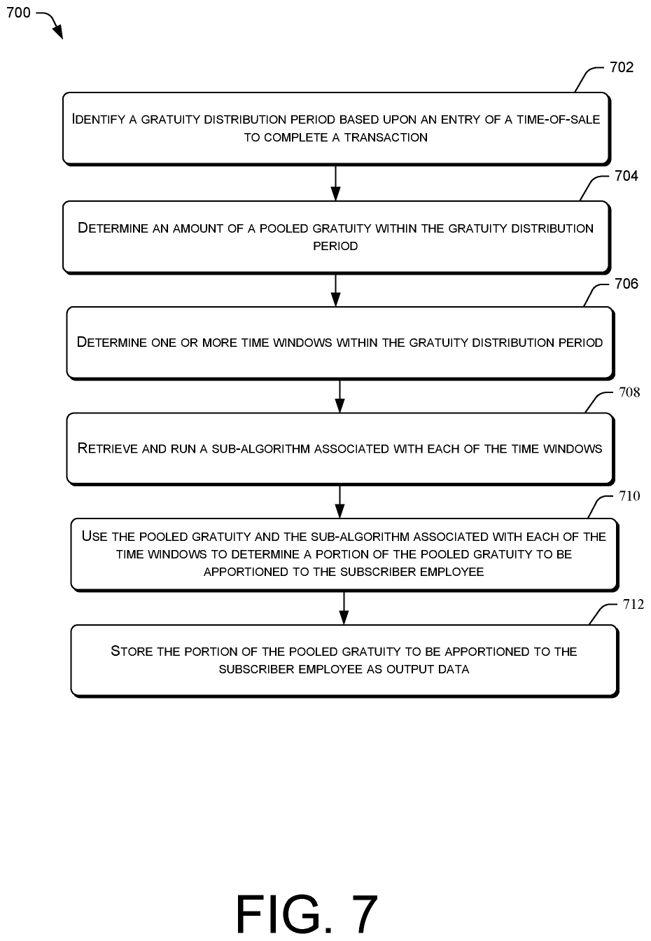

FIG. 7 is a flow diagram of an example methodological implementation 700 for determining an amount of pooled gratuity to be apportioned at the end of a gratuity distribution period for a particular employee, in accordance with at least one embodiment. In the following discussion of FIG. 7, continuing reference is made to the elements and reference numerals shown in and described with respect to the network server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 702, the network server 202 may identify a gratuity distribution period based upon an entry of a time-of-sale to complete a transaction. The gratuity distribution period may include a periodic cycle such as every hour, day, week, and the like. The gratuity distribution period may also include an aperiodic period such as upon completion of an order or transaction, upon random clocking in and out of an employee as the need arises, or any other aperiodic cycle. In one embodiment, the network server 202 may identify the gratuity distribution period based upon the entry of time-of-sale (input data) to complete the order or transaction. In this embodiment, the aperiodic identified gratuity distribution period may range from the opening of the order up to the closing of the order, which can be represented by the entry of the time-of-sale for the completed order or transaction. The opening of the order, for example, may include assigning of a tab number, entering a dining table for a customer, clearing a reservation upon arrival of the customer, receiving of customer's car by a valet driver, or other conditions that can be preconfigured as a start or the opening of an order.

At block 704, the network server 202 may determine an amount of a pooled gratuity within the gratuity distribution period. In one example, the amount of the pooled gratuity at an end of the identified gratuity distribution period may be apportioned to one or more subscriber employees that have a claim to the pooled gratuity. The claim may be based, for example, upon their contribution to service of the customer and/or other arbitrary conditions that may be preconfigured for a particular situation.

At block 706, the network server 202 may determine one or more time windows within the gratuity distribution period. In one embodiment, a change in time window triggered by a change in a job assignment may in turn cause a change in percentage sharing of the subscriber employee in the pooled gratuity. For example, an employee who initially worked as a bartender, which is associated with a first predetermined percentage sharing of the pooled gratuity, whose work assignment changes that correspond to a different percentage sharing of the pooled gratuity, then a new time window is generated, which may correspond to a different percentage enforced by a new sub-algorithm.

At block 708, the network server 202 may retrieve and run a sub-algorithm associated with each of the time windows. The network server 202, for example, may use the LUT to retrieve the corresponding sub-algorithm associated with the condition that occurred.

At block 710, the network server 202 may use the pooled gratuity and the sub-algorithm(s) associated with each of the time windows to determine a portion of the pooled gratuity to be apportioned to the subscriber employee. For example, a constraint equation such as the constraint equation 360 of FIG. 3 may equate the summation of gratuity distributions from the corresponding sub-algorithms of the time windows with the pooled gratuity to be distributed in order to determine the portion of the pooled gratuity to be apportioned to each. In this example, the use of the constraint equation and sub-algorithm associated with each of the time windows may determine a portion of the pooled gratuity to be apportioned to a particular employee.

At block 712, the network server 202 may store the portion of the pooled gratuity to be apportioned to the subscriber employee as output data. For example, the output data may be stored in a database where one or more subscriber-authorized entities may access and process the output data.

### Example Implementation—Executing Sub Algorithms

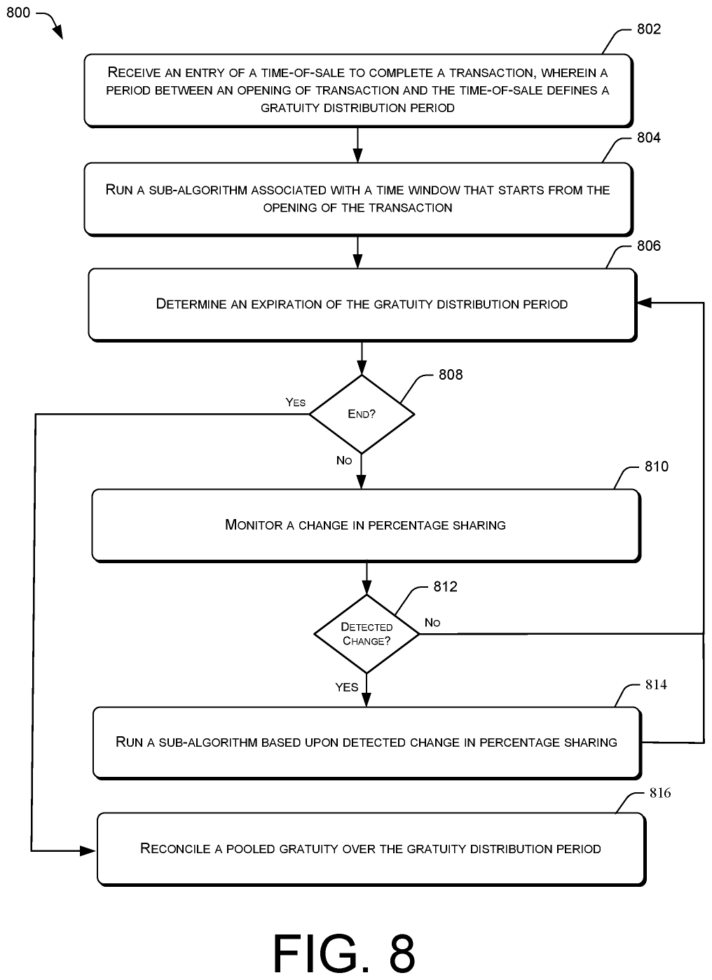

FIG. 8 is a flow diagram of an example methodological implementation 800 for executing one or more sub-algorithms within the gratuity distribution period. In the following discussion of FIG. 8, continuing reference is made to the elements and reference numerals shown in and described with respect to the network server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 802, the network server 202 may receive an entry of a time-of-sale to complete a transaction where a period between an opening of the transaction and the time-of-sale can define an aperiodic gratuity distribution period.

At block 804, the network server 202 may run a sub-algorithm that starts from the opening of the transaction. For example, an initial time window such as the first time window X1 492 may start from the opening of the transaction. In this example, the network server 202 may run a corresponding sub-algorithm until an occurrence of a condition that corresponds to changes in percentage sharing of the employee to the pooled gratuity. The occurrence of the condition may generate, for example, a new time window such as the second time window X2 494.

At block 806, the network server 202 may determine an expiration of the gratuity distribution period. For example, the completed transaction has a period of 3 hours. In this example, the network server 202 may determine whether the gratuity distribution period of 3 hours has expired.

If the gratuity distribution period has not yet expired (“No” at decision block 808), then, at block 810, the network device may monitor any changes in the percentage sharing of the subscriber employee. If a change in percentage sharing is detected (“Yes” at decision block 812), then, at block 814, the network device may run a new sub-algorithm that corresponds to the change in percentage sharing. The network server, for example, may use the LUT to identify the sub-algorithm that is associated with the change in percentage sharing. The new sub-algorithm is executed until the end of the gratuity distribution period is detected at block 806.

Going back at decision block 808 where the end of the gratuity distribution period is detected (“Yes” at block 808), then at block 816, the network server may reconcile the pooled gratuity.

Going back at decision block 812 where no change in the percentage sharing is monitored by the network server (“No” at block 812), then at block 806, the network server may continue to detect end of the gratuity distribution period.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed is:

1. One or more computer-readable storage media storing computer-executable instructions that upon execution cause one or more processors to perform acts comprising:
identifying a gratuity distribution period for a particular subscriber employee;
determining an amount of a pooled gratuity within the gratuity distribution period;
determining one or more time windows within the gratuity distribution period;
retrieving a sub-algorithm associated with each of the time windows;
using the amount of the pooled gratuity and the sub-algorithm associated with each of the time windows to determine a portion of the pooled gratuity to be apportioned to the subscriber employee; and
storing the portion of the pooled gratuity to be apportioned to the subscriber employee as output data.

2. The one or more computer-readable storage media of claim 1, wherein the gratuity distribution period includes a range that starts from an opening of a transaction to an entry of a time-of-sale to complete the transaction.

3. The one or more computer-readable storage media of claim 2, wherein a change in time window is triggered by a change in a percentage sharing of the subscriber employee to the pooled gratuity.

4. The one or more computer-readable storage media of claim 3, wherein the change in percentage sharing is associated with a change of work assignment of the subscriber employee.

5. The one or more computer-readable storage media of claim 3, wherein the acts further comprise: using a look-up table (LUT) to retrieve the sub-algorithm associated with the percentage sharing of the subscriber employee.

6. The one or more computer-readable storage media of claim 1, wherein the pooled gratuity is shared by the subscriber employee with another subscriber employee.

7. The one or more computer-readable storage media of claim 1, wherein one or more entities access the output data for further processing.

8. The one or more computer-readable storage media of claim 7, wherein at least one of the entities includes a financial institution that facilitates a direct payment of a wage of the subscriber employee.

9. The one or more computer-readable storage media of claim 8, wherein the wage comprises one or more gratuity distribution periods.

10. The one or more computer-readable storage media of claim 1, wherein the one or more time windows are associated with an arbitrary condition that corresponds to different percentage sharing by the subscriber employee.

11. A server-implemented system, comprising:
one or more processors;
computer-executable instructions stored in a memory that, if executed by the one or more processors, cause the one or more processors to perform operations comprising:
identifying a gratuity distribution period for a particular subscriber employee;
determining an amount of a pooled gratuity within the gratuity distribution period;
determining one or more time windows within the gratuity distribution period;
retrieving a sub-algorithm associated with each of the time windows;
using the amount of the pooled gratuity and the sub-algorithm associated with each of the time windows to determine a portion of the pooled gratuity to be apportioned to the subscriber employee; and
storing the portion of the pooled gratuity to be apportioned to the subscriber employee as output data.

12. The server-implemented system of claim 11, wherein the gratuity distribution period includes a range that starts from an opening of a transaction to an entry of a time-of-sale to complete the transaction.

13. The server-implemented system of claim 12, wherein a change in time window is triggered by a change in a percentage sharing of the subscriber employee to the pooled gratuity.

14. The server-implemented system of claim 13, wherein the change in percentage sharing is associated with a change of work assignment of the subscriber employee.

15. The server-implemented system of claim 13, wherein the operations further comprise: using a look-up table (LUT) to retrieve the sub-algorithm associated with the percentage sharing of the subscriber employee.

16. The server-implemented system of claim 11, wherein the pooled gratuity is shared by the subscriber employee with another subscriber employee.

17. The server-implemented system of claim 11, wherein the one or more time windows are associated with an arbitrary condition that corresponds to different percentage sharing by the subscriber employee.

18. A computer-implemented method, comprising:
identifying a gratuity distribution period for a particular subscriber employee;
determining an amount of a pooled gratuity within the gratuity distribution period;
determining one or more time windows within the gratuity distribution period. wherein a change in time window is triggered by a change in a percentage sharing of the subscriber employee to the pooled gratuity;
retrieving a sub-algorithm associated with each of the time windows;
using the amount of the pooled gratuity and the sub-algorithm associated with each of the time windows to determine a portion of the pooled gratuity to be apportioned to the subscriber employee; and
storing the portion of the pooled gratuity to be apportioned to the subscriber employee as output data.

19. The computer-implemented method of claim 18, wherein the gratuity distribution period includes a range that starts from an opening of a transaction to an entry of a time-of-sale to complete the transaction.

20. The computer-implemented method of claim 18, wherein the one or more time windows are associated with an arbitrary condition that corresponds to different percentage sharing by the subscriber employee.
